(19) United States
(12) Patent Application Publication
(10) Pub. No.: US 2024/0426232 A1
(43) Pub. Date: Dec. 26, 2024

(54) PRE-INJECTION UREA DECOMPOSITION

(71) Applicant: Caterpillar Inc., Peoria, IL (US)

(72) Inventor: Andrew Michael DENIS, Peoria, IL (US)

(73) Assignee: Caterpillar Inc., Peoria, IL (US)

(21) Appl. No.: 18/214,439

(22) Filed: Jun. 26, 2023

(51) Int. Cl. F01N 3/20; F01N 3/28

(52) U.S. Cl. CPC F01N 3/2066; F01N 3/2892; F01N 2570/14; F01N 2610/02; F01N 2610/1453

(57) ABSTRACT

Traditionally, diesel exhaust fluid (DEF) injection rates in aftertreatment systems for diesel engines must be restricted at low temperatures to prevent urea crystallization at and beyond the point of injection. Urea crystallization can reduce the amount of diesel exhaust fluid that can be injected, decrease the efficiency of nitrogen-oxides (NOₓ) reduction process, and the like. Disclosed embodiments utilize a catalyst material upstream from the point of injection to convert urea into ammonia, prior to injection. This eliminates or reduces urea crystallization at and beyond the point of injection.

### TECHNICAL FIELD

The embodiments described herein are generally directed to selective catalytic reduction, and, more particularly, to the injection of diesel exhaust fluid as a reductant for selective catalytic reduction.

### BACKGROUND

In selective catalytic reduction (SCR), nitrogen oxides (NOₓ) are converted into diatomic nitrogen (N₂) and water (H₂O). In particular, a reductant solution, also referred to as diesel exhaust fluid (DEF), is added to a flow of exhaust from a diesel engine. The flow of exhaust gas, with the added diesel exhaust fluid, is reacted onto a catalyst. This reaction pulls harmful products out of the exhaust.

The diesel exhaust fluid may comprise anhydrous ammonia (NH₃), aqueous ammonia (NH₄OH), or urea (CO(NH₂)₂). However, urea is generally preferred, since it is more stable and less toxic than ammonia. In other words, it is safer to store urea than ammonia. When urea is used as the diesel exhaust fluid, the reaction with the catalyst produces nitrogen, water, and carbon dioxide (CO₂).

At high temperatures, the urea will decompose into ammonia. However, if too much urea is injected into the flow of exhaust, the relatively cooler urea may lower the temperature of the relatively hotter exhaust. At this lowered temperature, there may not be sufficient decomposition energy to convert the urea into ammonia. In this case, the urea that is injected into the flow of exhaust will crystallize. This crystallized urea may form deposits on surfaces at the injection point, on mixing elements, along the mixing channel, and/or the like. These deposits can increase backpressure on the engine and reduce the amount of diesel exhaust fluid that can be injected (e.g., by clogging the injection nozzle), thereby decreasing the efficiency of the NOₓ reduction process.

Thus, DEF injection rates are limited by the temperature of exhaust. When the temperature of the exhaust is too low, the rate of DEF injection must be restricted to prevent urea crystallization. This limits NOₓ conversion at low temperatures, and can affect the aggressiveness of the exhaust mixing and the required backpressure.

Examples of aftertreatment systems that utilize selective catalytic reduction are described in U.S. Pat. Nos. 9,221,016, 10,058,819, and U.S. Patent Pub. No. 2017/0234188. Notably, U.S. Pat. No. 9,221,016 and U.S. Patent Pub. No. 2017/0234188 utilize an exhaust heater to manage the temperature of the exhaust. None of these references attempt to address the problem at a point that is prior to injection of the diesel exhaust fluid. The present disclosure is directed toward overcoming one or more of the problems discovered by the inventors.

### SUMMARY

In an embodiment, an aftertreatment system comprises: a mixing channel defining a flow path for exhaust from an internal combustion engine that combusts diesel fuel; an injector comprising at least one nozzle and configured to inject diesel exhaust fluid (DEF) into the mixing channel, wherein the diesel exhaust fluid comprises urea; and a catalyst material upstream from the at least one nozzle, with respect to a direction of flow of the diesel exhaust fluid, wherein the catalyst material converts urea into ammonia when fluidly contacted by the urea.

In an embodiment, An aftertreatment system comprises: a mixing channel defining a flow path for exhaust from an internal combustion engine that combusts diesel fuel; a lance that spans the mixing channel, orthogonally to the flow path, wherein the lance includes a diesel exhaust fluid (DEF) port, at least one nozzle, and a DEF channel between the DEF port and the at least one nozzle, wherein the at least one nozzle is configured to inject diesel exhaust fluid into the mixing channel, and wherein the diesel exhaust fluid comprises urea; and a catalyst material coating at least a portion of an inner surface of the DEF channel, wherein the catalyst material converts urea into ammonia when fluidly contacted by the urea.

In an embodiment, an aftertreatment system comprises: a mixing channel defining a flow path for exhaust from an internal combustion engine that combusts diesel fuel; an injector comprising at least one nozzle and configured to inject diesel exhaust fluid (DEF) into the mixing channel, wherein the diesel exhaust fluid comprises urea; and a decomposition system that includes a DEF inlet that is in fluid communication with a DEF supply, a channel, wherein at least a portion of an inner surface of the channel is coated with a catalyst material that converts urea into ammonia when fluidly contacted by the urea, and a DEF outlet that is in fluid communication with the injector.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a schematic diagram of a machine with an internal combustion engine, according to an embodiment;

FIG. 2 illustrates a cross-sectional view of a catalyst-based aftertreatment system, according to an embodiment;

FIG. 3 illustrates a cross-sectional view of an injector, according to an embodiment; and

FIG. 4 illustrates a cross-sectional view of a decomposition system, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

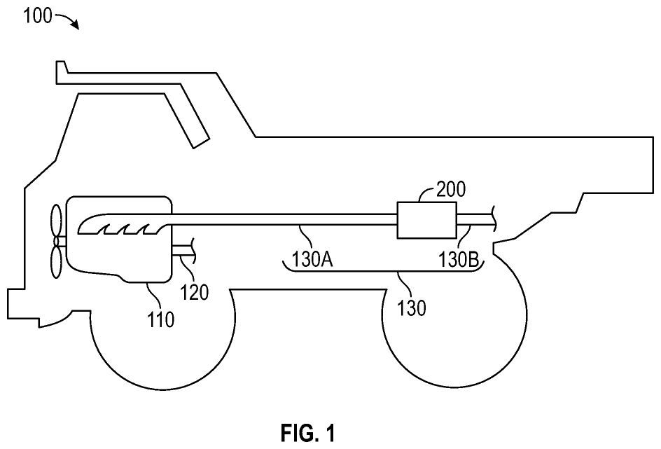

FIG. 1 illustrates a schematic diagram of a machine 100 with an internal combustion engine 110, according to an embodiment. Machine 100 may be any mobile or stationary equipment that utilizes combustion and produces exhaust. Examples of mobile equipment include, without limitation, an excavator, wheel loader, dump truck, asphalt paver, backhoe loader, skid steer, track loader, cold planer, compactor, dozer, electric rope shovel, forest machine, hydraulic mining shovel, material handler, motor grader, pipe-layer, road reclaimer, telehandler, tractor-scraper, or the like, as well as ordinary road vehicles (e.g., automobiles, semi-tractors, etc.), aircraft, or maritime vessels (e.g., boats, ships, etc.). Examples of stationary equipment include, without limitation, a power generator, a gas compressor, and the like. However, it should be understood that machine 100 may be any apparatus that is powered by an internal combustion engine 110.

It is generally contemplated that internal combustion engine 110 will utilize diesel fuel for combustion. However, it should be understood that disclosed embodiments could be adapted for machines 100 that utilize other types of fuel. For example, the disclosed embodiments could be adapted to work with an engine that utilizes natural gas.

Internal combustion engine 110 may comprise a plurality of cylinders. Internal combustion engine 110 combusts diesel fuel which drives the cylinders. These cylinders rotate a shaft 120, which drives machine 100 (e.g., the axles of a mobile machine, the rotor of a compressor, etc.). Internal combustion engine 110 may also comprise an exhaust manifold that channels exhaust, produced by combustion within internal combustion engine 110, into an exhaust conduit 130, which is illustrated as comprising segments 130A and 130B. While only a single exhaust conduit 130 is illustrated, machine 100 may comprise a plurality of exhaust conduits 130, which may provide multiple (e.g., parallel) flow paths for the exhaust. Each exhaust conduit 130 carries exhaust away from internal combustion engine 110 and towards an exhaust outlet of machine 100.

Each exhaust conduit 130 may run the exhaust through an aftertreatment system 200 that is upstream from the exhaust outlet of machine 100. While only a single aftertreatment system 200 is illustrated, machine 100 may comprise a plurality of aftertreatment systems 200 connected in series (e.g., on the same flow path) or in parallel (e.g., on separate flow paths). Aftertreatment system 200 may be a catalytic converter or other catalyst-based system, which converts harmful pollutants into less harmful emissions before being expelled from an outlet of exhaust conduit 130.

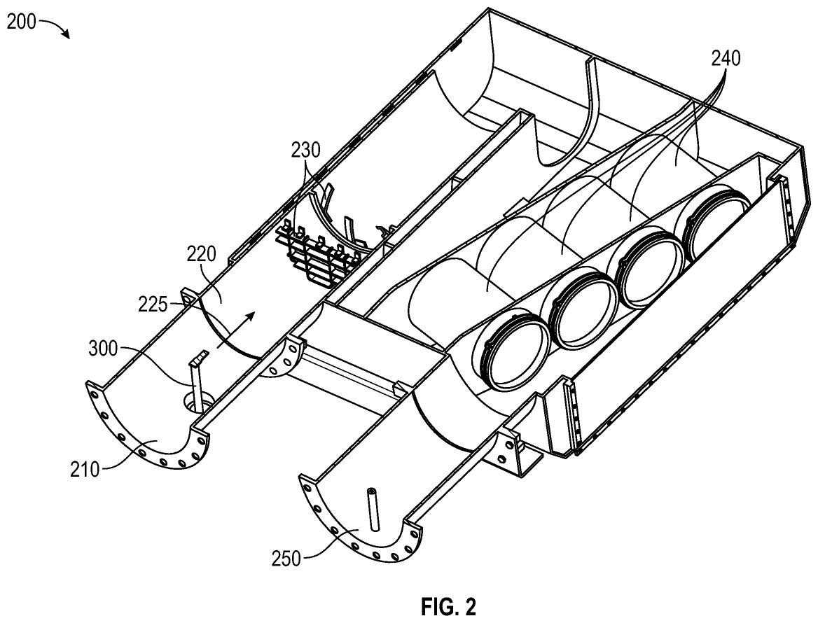

FIG. 2 illustrates a cross-sectional view of a catalyst-based aftertreatment system 200, according to an embodiment. Aftertreatment system 200 may be connected, on an upstream end, to a downstream end of segment 130A of exhaust conduit 130, and connected, on a downstream end, to an upstream end of segment 130B of exhaust conduit 130. It should be understood that, in this context, the terms “upstream” and “downstream” are relative to the direction of flow of the exhaust. Exhaust from segment 130A of exhaust conduit 130 flows into an inlet 210 which is in fluid communication with a mixing channel 220. The exhaust flows along a flow path 225 through mixing channel 220. The exhaust will flow, in order, past an injector 300, through one or more mixing elements 230, through one or more catalysts 240, and out an outlet 250. At outlet 250, the treated exhaust will flow into the upstream end of segment 130B of exhaust conduit 130, after which it may be expelled from an exhaust outlet of machine 100.

Injector 300 injects the reductant of aftertreatment system 200 into flow path 225. In an embodiment, injector 300 comprises a DEF injection lance that spans an entire diameter of mixing channel 220, with a single nozzle positioned substantially at or near the center of flow path 225, so as to inject the reductant into the middle of the flow of exhaust. The nozzle may face downstream, such that the reductant is injected with the flow of exhaust. However, it should be understood that other arrangements are possible. For example, injector 300 could comprise a plurality of nozzles, injector 300 could comprise a nozzle that faces upstream or a direction that is orthogonal to the flow of exhaust or at some other non-zero angle with respect to the flow of exhaust, injector 300 could be replaced with another system that spans only a partial diameter of mixing channel 220 or injects diesel exhaust fluid from a side or other position of mixing channel 220, and/or the like.

In any case, diesel exhaust fluid is injected into the exhaust in flow path 225, upstream from one or more mixing elements 230. Mixing element(s) 230 span mixing channel 220 in a direction substantially orthogonal to flow path 225, such that the exhaust must flow through mixing element(s) 230. Mixing element(s) 230 may comprise a honeycomb pattern, swirler vanes, and/or the like, that are designed to mix the exhaust with the injected diesel exhaust fluid. Ideally, after passing through mixing element(s) 230, the diesel exhaust fluid will be uniformly distributed throughout the exhaust.

This mixture of exhaust and diesel exhaust fluid then flows into the upstream end of one or more catalysts 240. While four catalysts 240 are illustrated, aftertreatment system 200 may comprise any number of catalysts 240, including one, two, three, or five or more catalysts 240. Each catalyst 240 may comprise a support, which may be formed from a porous ceramic material (e.g., titanium oxide), and an active catalytic component. The support may have a honeycomb or plate geometry. The active catalytic component may comprise an oxide of base metals (e.g., vanadium, molybdenum, tungsten, etc.), zeolites, or various precious metals. As the mixture of exhaust and diesel exhaust fluid flows through each catalyst 240, the diesel exhaust fluid sets off a chemical reaction that converts the nitrogen oxides in the exhaust into nitrogen, water, and carbon dioxide. These components may then flow out of the downstream ends of catalyst(s) 240 and out of outlet 250 into the upstream end of segment 130B of exhaust conduit 130.

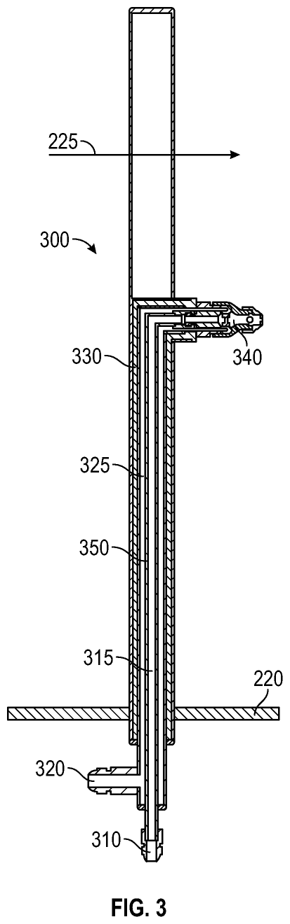

FIG. 3 illustrates a cross-sectional view of an injector 300, according to an embodiment. In the illustrated embodiment, injector 300 comprises a lance that extends through a wall of mixing channel 220 into flow path 225, along a radial axis that is orthogonal to flow path 225.

The portion of injector 300 outside of mixing channel 220 and flow path 225 may comprise a DEF port 310 and an air port 320. DEF port 310 may be connected to a DEF supply (not shown), which supplies diesel exhaust fluid to a DEF channel 315. Similarly, air port 320 may be connected to an air supply (not shown), which supplies air to an air channel 325.

DEF channel 315 and air channel 325 may be concentric with each other around a longitudinal axis of injector 300 (i.e., orthogonal to flow path 225), with one of DEF channel 315 and air channel 325 encircled by the other one of the DEF channel 315 and air channel 325, for example, as concentric tubes. In the illustrated embodiment, DEF channel 315 is defined by an inner tube, whereas air channel 325 encircles DEF channel 315 and is defined by the outer surface of the inner tube and the inner surface of an outer tube encircling the inner tube. In an alternative embodiment, air channel 325 could be defined by the inner tube, and DEF channel 315 could be defined by the outer surface of the inner tube and the inner surface of the outer tube.

At least the portion of injector 300 that extends through the wall of mixing channel 220 and across flow path 225 may also comprise an insulator 330. For example, insulator 330 may comprise an insulating tube that encircles the portions of DEF channel 315 and air channel 325 that extend into mixing channel 220. Insulator 330 may comprise a channel, defined by the outer surface of the outer tube (e.g., defining air channel 325) and the inner surface of the insulating tube, which may be filled with an insulating material (e.g., a gas, liquid, or solid). Alternatively, insulator 330 could consist of an insulating tube, made of an insulating material, whose inner diameter matches the outer diameters of the outer tube, such that no channel is formed therebetween.

Each of DEF channel 315 and air channel 325 are in fluid communication with a nozzle 340. As illustrated, nozzle 340 may face downstream, relative to flow path 225. Nozzle 340 may be configured to atomize the fluid in DEF channel 315 using the air in air channel 325, such that a mixture of the fluid and air is injected into flow path 225 as a fine mist.

Traditionally, the fluid being injected into flow path 225 by nozzle 340 is the diesel exhaust fluid, and particularly, urea. However, in disclosed embodiments, a catalyst is used upstream from nozzle 340, to decompose the urea into ammonia, prior to the injection into flow path 225 by nozzle 340. It should be understood that, in the context of this injection, the terms “upstream” and “downstream” are relative to the direction of flow of diesel exhaust fluid from the DEF supply to nozzle 340.

In a first embodiment, the inner surface of the tube defining DEF channel 315 is coated with catalyst material 350. Catalyst material 350 may comprise urease, oxides, such as alumina, silica, and palladium complexes, or any other material that promotes the conversion of urea to ammonia. Preferably, catalyst material 350 will convert urea into ammonia at relatively low temperatures (e.g., at or around approximately 100-degrees Celsius, or between 100-degrees Celsius and 180-degrees Celsius). As the urea flows through DEF channel 315, the urea fluidly contacts and reacts with catalyst material 350 on the inner surface of the tube. This reaction causes the urea to decompose into ammonia, such that, at the downstream end of DEF channel 315, the urea has been decomposed into ammonia. Thus, nozzle 340 injects ammonia, rather than urea, into the exhaust in flow path 225.

It should be understood that, in practice, the urea may not be perfectly decomposed into ammonia, such that the diesel exhaust fluid that is injected by nozzle 340 may comprise both urea and ammonia, as well as potentially water. The actual percentage of urea that is converted into ammonia will depend on catalyst material 350, the size of the area in which catalyst material 350 is in fluid contact with diesel exhaust fluid in DEF channel 315 (e.g., as defined by the length of DEF channel 315), the temperature in DEF channel 315, and/or the like.

Notably, since injector 300 spans flow path 225, injector 300 is exposed to the heat of the exhaust in flow path 225. This waste heat may be used as decomposition energy to aid in the decomposition of urea into ammonia within DEF channel 315. Generally, urea will decompose into ammonia at 180-degrees Celsius. However, this temperature may not be sustainable. Catalyst material 350 aids the decomposition at lower temperatures, so as to effectively lower the decomposition temperature.

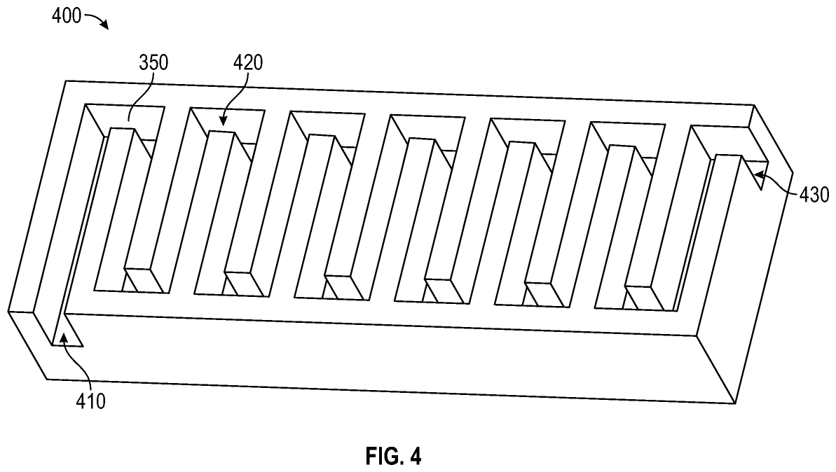

FIG. 4 illustrates a cross-sectional view of a decomposition system 400, according to a second embodiment. In this second embodiment, a decomposition system 400 is incorporated into aftertreatment system 200. Decomposition system 400 may be used instead of coating the inner surface of the tube, defining DEF channel 315 in injector 300, with catalyst material 350. Alternatively, decomposition system 400 could be used in addition to coating the inner surface of the tube, defining DEF channel 315 in injector 300, with catalyst material 350. In other words, the first and second embodiments are not mutually exclusive.

Decomposition system 400 comprises a DEF inlet 410, a channel 420, and a DEF outlet 430. Decomposition system 400 may be positioned upstream from injector 300, with respect to the direction of flow of urea. For instance, DEF outlet 430 may be connected, directly or indirectly, to DEF port 310 of injector 300, so as to be in fluid communication with DEF port 310. DEF inlet 410 may be connected, directly or indirectly, to the DEF supply, so as to be in fluid communication with the DEF supply. Thus, diesel exhaust fluid flows from the DEF supply into DEF inlet 410, through channel 420, and out DEF outlet 430 into DEF port 310 of injector 300.

The inner surface of channel 420 may be coated with catalyst material 350, as described above. In addition, channel 420 may be serpentine (i.e., turning back on itself numerous times), such that a longer channel 420 can be fit into a smaller area. By lengthening channel 420 in this manner, the diesel exhaust fluid, flowing through channel 420, is exposed to and fluidly contacts a greater area of catalyst material 350, thereby increasing the opportunity for catalyst material 350 to cause the decomposition reaction from urea into ammonia. The length of channel 420 may be set sufficiently long to ensure 100% conversion or close to 100% conversion of the urea into ammonia, even at a temperature which will be significantly lower than the temperature in DEF channel 315. Thus, urea may flow into DEF inlet 410, be converted into ammonia within channel 420. The ammonia may flow from DEF outlet 430 into DEF port 310, through DEF channel 315, be atomized by air in air channel 325, and sprayed from nozzle 340 into the exhaust in flow path 225.

In an alternative embodiment, channel 420 could have other shapes or profiles, including a completely linear profile, a serpentine profile with non-right angles, a winding or torturous profile with any plurality of twists, bends, or turns, or any combination of different profiles. The particular profile may be dictated by the desired length of channel 420 or other design objectives, the manufacturing process being used, the material being used for decomposition system 400, and/or the like.

In an alternative embodiment of decomposition system 400, decomposition system 400 could comprise a heating circuit instead of or in addition to catalyst material 350. This heating circuit may heat channel 420 to the decomposition temperature for the conversion of urea into ammonia (e.g., 180-degrees Celsius). In this case, as urea flows through channel 420, it may thermally decompose into ammonia, prior to exiting DEF outlet 430.

It should be understood that decomposition system 400 may be used with any type of mechanism for injecting diesel exhaust fluid into mixing channel 220. Thus, while injector 300 is illustrated as an air-assisted lance, other types of injectors may be used instead. Other types of injectors include other types of air-assisted injectors, similar to the illustrated injector 300, as well as airless injectors. Example of airless injectors that may be used with decomposition system 400 include any of the DEF injectors manufactured by or for Robert Bosch GmBH of Gerlingen, Germany. In addition, while aftertreatment system 200 is illustrated as consisting of only a single injector 300, aftertreatment system 200 could instead could instead comprise a plurality of injectors 300. The plurality of injectors 300 may be arranged at different positions circumferentially around mixing channel 220 and/or longitudinally along mixing channel 220. The DEF inlet 310 of each of the plurality of injectors 300 may be connected to the DEF outlet 430 of the same decomposition system 400 or separate decomposition systems 400.

### INDUSTRIAL APPLICABILITY

Traditionally, DEF injection rates in aftertreatment systems for diesel engines must be restricted at low temperatures to prevent urea crystallization at and beyond the point of injection. Urea crystallization can reduce the amount of diesel exhaust fluid that can be injected, decrease the efficiency of the NOₓ reduction process, and the like. Disclosed embodiments utilize a catalyst material 350 upstream from the point of injection to convert all or a substantial part of the urea into ammonia, prior to injection. This eliminates or reduces urea crystallization on nozzle 340, within mixing channel 220, and the like.

In a first embodiment, catalyst material 350 may be coated on an inner surface of a DEF channel 315 within injector 300, between DEF inlet 310 and nozzle 340. This enables the decomposition of urea into ammonia to take place very close to the point of injection (i.e. nozzle 340), such that the ammonia only exists within machine 100 for a very short time.

In a second embodiment, a decomposition system 400 is provided upstream from injector 300. Decomposition system 400 comprises a longer channel 420, relative to DEF channel 315. This long channel 420 is coated with catalyst material 350 to decompose the urea into ammonia, prior to entering DEF port 310 of injector 300. Decomposition system 400 may be installed immediately upstream from injector 300, in order to minimize the amount of time that the ammonia exists within machine 100. This second embodiment may be used instead of the first embodiment or in addition to the first embodiment.

Notably, the second embodiment may be easier to manufacture than the first embodiment. In particular, decomposition system 400 may have greater clearances and tolerances than injector 300, which may enable catalyst material 350 to be more easily applied.

In addition, the second embodiment may be enable easier retrofitting for existing machines 100. In particular, decomposition system 400 may be installed in place of an existing supply line between the DEF supply and DEF inlet 310. This may be simpler than replacing an existing lance with a new injector 300 comprising catalyst material 350 or retrofitting the existing lance with catalyst material 350.

In either embodiment, the conversion of urea into ammonia, upstream from the injection point, lowers the risk of urea crystallization and increases the maximum DEF injection rate in aftertreatment system 200. In addition, because the ammonia is consumed as it is created, ammonia does not have to be stored on site (e.g., within machine 100), and there will be minimal ammonia in machine 100 during shutdown or purging.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of apparatus. Hence, although the present embodiments are, for convenience of explanation, depicted and described as being implemented in the aftertreatment system for the exhaust of a diesel engine, it will be appreciated that it can be implemented in various other types of systems and/or for other types of fuels, and in various other environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

1. An aftertreatment system comprising:
a mixing channel defining a flow path for exhaust from an internal combustion engine that combusts diesel fuel;
an injector comprising at least one nozzle and configured to inject diesel exhaust fluid (DEF) into the mixing channel, wherein the diesel exhaust fluid comprises urea;
a DEF channel in fluid communication with the at least one nozzle; and
a catalyst material in the DEF channel upstream from the at least one nozzle, with respect to a direction of flow of the diesel exhaust fluid, wherein the catalyst material converts urea into ammonia when fluidly contacted by the urea.

2. The aftertreatment system of claim 1, wherein the injector comprises a lance that spans the mixing channel, orthogonally to the flow path.

3. The aftertreatment system of claim 2, wherein the lance comprises a DEF port and the DEF channel extends between the DEF port and the at least one nozzle, and wherein at least a portion of an inner surface of the DEF channel is coated with the catalyst material.

4. The aftertreatment system of claim 3, wherein the lance comprises an air port and an air channel between the air port and the at least one nozzle, wherein the air channel is concentric with the DEF channel, and wherein the at least one nozzle atomizes the diesel exhaust fluid in the DEF channel using air in the air channel when injecting the diesel exhaust fluid into the mixing channel.

5. The aftertreatment system of claim 1, further comprising a decomposition system that includes:
a DEF inlet that is in fluid communication with a DEF supply;
wherein at least a portion of an inner surface of the DEF channel is coated with the catalyst material; and
a DEF outlet that is in fluid communication with the injector.

6. The aftertreatment system of claim 5, wherein the DEF channel comprises a plurality of twists, bends, or turns.

7. The aftertreatment system of claim 5, wherein the injector comprises a lance that spans the mixing channel, orthogonally to the flow path, wherein the lance includes a DEF port and the DEF channel extends between the DEF port and the at least one nozzle, and wherein the DEF port of the lance is in fluid communication with the DEF outlet.

8. The aftertreatment system of claim 7, wherein the lance comprises an air port and an air channel between the air port and the at least one nozzle, wherein the air channel is concentric with the DEF channel, and wherein the at least one nozzle atomizes the diesel exhaust fluid in the DEF channel using air in the air channel when injecting the diesel exhaust fluid into the mixing channel.

9. The aftertreatment system of claim 1, further comprising:
one or more mixing elements downstream from the injector, with respect to a direction of flow of the exhaust; and
one or more catalysts downstream from the one or more mixing elements, wherein each of the one or more catalysts includes an active catalytic component that, when reacting with the ammonia, converts nitrogen oxides in the exhaust into nitrogen and water.

10. A machine comprising:
the internal combustion engine;
an exhaust conduit that carries exhaust away from the internal combustion engine; and
at least one of the aftertreatment system of claim 1 in a flow path of the exhaust conduit.

11. The machine of claim 10, wherein the machine is a vehicle.

12. The machine of claim 10, wherein the machine is a power generator.

13. An aftertreatment system comprising:
a mixing channel defining a flow path for exhaust from an internal combustion engine that combusts diesel fuel;
a lance that spans the mixing channel, orthogonally to the flow path, wherein the lance includes a diesel exhaust fluid (DEF) port, at least one nozzle, and a DEF channel between the DEF port and the at least one nozzle, wherein the at least one nozzle is configured to inject DEF into the mixing channel, and wherein the diesel exhaust fluid comprises urea; and
a catalyst material coating at least a portion of an inner surface of the DEF channel, wherein the catalyst material converts urea into ammonia when fluidly contacted by the urea.

14. The aftertreatment system of claim 13, wherein the lance further includes an air port and an air channel between the air port and the at least one nozzle, wherein the air channel is concentric with the DEF channel, and wherein the at least one nozzle atomizes the diesel exhaust fluid in the DEF channel using air in the air channel when injecting the diesel exhaust fluid into the mixing channel.

15. The aftertreatment system of claim 13, further comprising:
one or more mixing elements downstream from the lance, with respect to a direction of flow of the exhaust; and
one or more catalysts downstream from the one or more mixing elements, wherein each of the one or more catalysts includes an active catalytic component that, when reacting with the ammonia, converts nitrogen oxides in the exhaust into nitrogen and water.

16. A machine comprising:
the internal combustion engine;
an exhaust conduit that carries exhaust away from the internal combustion engine; and
at least one of the aftertreatment system of claim 13 in a flow path of the exhaust conduit.

17. An aftertreatment system comprising:
a mixing channel defining a flow path for exhaust from an internal combustion engine that combusts diesel fuel;
an injector comprising at least one nozzle and configured to inject diesel exhaust fluid (DEF) into the mixing channel, wherein the diesel exhaust fluid comprises urea; and
a decomposition system that includes
a DEF inlet that is in fluid communication with a DEF supply,
a channel, wherein at least a portion of an inner surface of the channel is coated with a catalyst material that converts urea into ammonia when fluidly contacted by the urea, and
a DEF outlet that is in fluid communication with the injector.

18. The aftertreatment system of claim 17, wherein the channel is serpentine.

19. The aftertreatment system of claim 17, further comprising:
one or more mixing elements downstream from the injector, with respect to a direction of flow of the exhaust; and
one or more catalysts downstream from the one or more mixing elements, wherein each of the one or more catalysts includes an active catalytic component that, when reacting with the ammonia, converts nitrogen oxides in the exhaust into nitrogen and water.

20. A machine comprising:
the internal combustion engine;
an exhaust conduit that carries exhaust away from the internal combustion engine; and
at least one of the aftertreatment system of claim 17 in a flow path of the exhaust conduit.
